(19) United States
(12) Patent Application Publication
(10) Pub. No.: US 2010/0257254 A1
(43) Pub. Date: Oct. 7, 2010

(54) Apparatus, Method and System for Securely Handling Digital Transaction Documents

(76) Inventors: Mayank Bhatnagar, Fremont, CA (US); Plamen A. Parvanov, Sunnyvale, CA (US); Prabhuram Mohan, San Jose, CA (US)

Correspondence Address: Clise, Billion & Cyr, P.A., 605 U.S. Highway 169, Suite 300, Plymouth, MN, 55441, US

(21) Appl. No.: 12/416,888

(22) Filed: Apr. 1, 2009

(51) Int. Cl. G06F 15/16

(52) U.S. Cl. 709/219

(57) ABSTRACT

A system is based on a three-way end-to-end methodology for securely delivering and managing digital transaction documents from a distributor to a user's trusted personal digital device via a secured digital transaction document server (“secured DTD server”). Once stored on the personal digital device, a secured digital transaction document may be decrypted for use at a transaction facility, or may be used at the transaction facility in encrypted form if the transaction facility is in communication with the secured DTD server for verification of the secured digital transaction document. The secured DTD server may also receive information from the transaction facility, and provide reports to the distributors for further action vis-à-vis the transaction facilities.

### BACKGROUND OF THE INVENTION

1. Field of the Invention

This invention relates to the secure handling of digital transaction documents, and more particularly to apparatus, methods and systems that involve a trusted personal digital device for securely handling digital transaction documents.

2. Description of the Related Art

A variety of small mobile personal digital devices that use MoBeam® technology to transmit information to standard point-of-sale (“POS”) barcode scanners are available from Ecrio Inc. of Cupertino, Calif., USA, and are described in one or more of the following patents: U.S. Pat. No. 6,685,093 issued Feb. 3, 2004 to Challa et al.; U.S. Pat. No. 6,877,665 issued Apr. 12, 2005 to Challa et al.; U.S. Pat. No. 7,028,906 issued Apr. 18, 2006 to Challa et al.; and U.S. Pat. No. 7,395,961 issued Jul. 8, 2008 to Challa et al. The MoBeam technology involves the beaming of pulsed light to barcode scanners to simulate the long-and-short sequencing of a standard barcode. The pulsed light is interpreted by the barcode scanners as a reflection from a printed paper barcode.

A particularly suitable application for devices enabled with the MoBeam technology is presentation of barcoded information at facilities equipped with standard barcode scanners, such as, for example, points-of-sale, event entry stations, and security checkpoints. Small, lightweight and simple handheld devices including, in particular, fob-type devices offer an extremely satisfying user experience at facilities equipped with bar code scanners because of their simplicity and convenient shape, size and weight of the device, and the speed, reliability, and ease-of-use of the MoBeam technology for presenting barcodes to barcode scanners.

While information for presentation at facilities equipped with bar code scanners may be placed on digital devices enabled with the MoBeam technology in many different ways, and can be conveniently and reliably presented with the MoBeam technology at such facilities, many problems can arise if one desires to restrict the downloading and use of this information. In the case of digital coupons, for example, ensuring that a particular downloaded coupon is redeemed only once is important for the typical reimbursement model to function correctly. Otherwise, the company obligated to reimbursement redemption of the coupon may be faced with an unexpectedly large obligation if copies of the coupon proliferate among consumers, or if a single coupon is fraudulently redeemed multiple times at a point-of-sale.

To avoid this problem, a company may implement a system in which redemption occurs digitally in a closed loop; see, for example, Progressive Grocer, Kroger/Atlanta Offering Coupons Via Mobile Phone, Jul. 30, 2008. Closed loop systems are effective for dealing with fraud and security concerns because a single company controls the generation and redemption of its coupons. Unfortunately, a closed loop system is of limited usefulness in the marketplace, where points-of-sale typically are not controlled by a single entity, and where each point-of-sale typically redeem coupons from many different coupon issuers.

### BRIEF SUMMARY OF THE INVENTION

What is needed is a technique to secure the delivery and use of information that may be presented during various types of transactions at various types of facilities. The technique should provide for transaction security, fraud prevention, and fraud detection. Variations of the technique should include a comprehensive and flexible capability for reporting details of the transactions. Other variations of the technique should be suitable for use with many different distributors and many different facilities involved in the transactions.

These and other problems in the art are each solved by one or more of the various embodiments of the present invention.

One embodiment of the invention is a. A server for securely delivering and managing digital transaction documents, comprising program components in tangible storage medium for receiving a digital transaction document (“DTD”) from a logically distinct distribution server; receiving a unique device identifier that uniquely identifies a trusted personal digital device (“PDD”); generating a secured DTD in accordance with the DTD and the unique device identifier; and delivering the secured DTD to the PDD.

Another embodiment of the invention is a system for securely delivering and managing digital transaction documents, comprising a personal digital device (“PDD”) having a memory and a unique device identifier; a distribution server for distributing a digital transaction document (“DTD”); and a secured DTD server for generating a secured DTD in accordance with the DTD and the unique device identifier, the secured DTD server being logically distinct from and in communication with the distribution server for receiving the DTD, and being in communication with the PDD for receiving the unique device identifier and for furnishing the secured DTD to the memory of the PDD.

Another embodiment of the invention is a method for securely delivering and managing digital transaction documents, comprising requesting a digital transaction document (“DTD”) from a distribution server with a personal digital device (“PDD”), the PDD having a memory and a unique device identifier; providing the DTD requested by the PDD in the requesting step to a secured DTD server from the distribution server, the secured DTD server being logically distinct from the distribution server; providing the unique device identifier to the secured DTD server from the PDD; generating in the secured DTD server a secured DTD in accordance with the DTD and the unique device identifier; and providing the secured DTD to the memory of the PDD from the secured DTD server.

### BRIEF DESCRIPTION OF THE SEVERAL VIEWS OF THE DRAWINGS

FIG. 1 is a schematic diagram showing the basic functional aspects of an illustrative system for securely generating and delivering digital transaction documents using a trusted personal digital device.

FIG. 2 is a schematic diagram of a system for providing secured digital transaction documents to a ClipPod-type trusted personal digital device via a host.

FIG. 3 is a schematic diagram of a system for providing digital transaction documents in either secured or unsecured form from a ClipPod device to a barcode scanner at a point-of-sale.

FIG. 4 is a schematic diagram of a system for providing secured digital transaction documents to a trusted personal digital device.

FIG. 5 is a schematic diagram of a system for providing digital transaction documents in either secured or unsecured form from a trusted personal digital device to a transaction facility.

FIG. 6 is a schematic flow diagram showing a suitable sequence of operations for one illustrative implementation of a system for securely handling digital transaction documents.

FIG. 7 is a schematic flow diagram showing a suitable sequence of operations for another illustrative implementation of a system for securely handling digital transaction documents.

FIG. 8 is a schematic flow diagram showing a suitable sequence of operations for another illustrative implementation of a system for securely handling digital transaction documents.

FIG. 9 is a schematic flow diagram showing a suitable sequence of operations for another illustrative implementation of a system for securely handling digital transaction documents.

FIG. 10 is a plan view of an illustrative fob-type personal digital device.

FIG. 11 is a plan view of another illustrative fob-type personal digital device.

FIG. 12 is a plan view of another illustrative fob-type personal digital device.

FIG. 13 is a plan view of another illustrative fob-type personal digital device.

FIG. 14 is a plan view of another illustrative fob-type personal digital device.

FIG. 15 is a flow diagram of a method for providing digital transaction documents as light pulses to a barcode reader.

### DETAILED DESCRIPTION OF THE INVENTION, INCLUDING THE BEST MODE

A system is based on a three-way end-to-end methodology for securely delivering and managing digital transaction documents from a distributor to a user's trusted personal digital device via a secure digital transaction document generator (“secured DTD generator”). Once stored on the personal digital device, a secured digital transaction document may be decrypted for use at a transaction facility, or may be used at the transaction facility in encrypted form provided that the transaction facility is in communication with the secured DTD generator for verification of the secured digital transaction document. The secured DTD generator may receive information about use of digital transaction documents from various transaction facilities, and provide reports to the distributors for further action (compensation, fraud mitigation, and so forth) vis-à-vis the transaction facilities.

A “digital transaction document” (“DTD”) may be any type of information that one may wish to communicate for the purpose of conducting a transaction that involves a digital electronic aspect, including information conventionally communicated using bar codes, as well as other types of information that are not conventionally communicated using bar codes because of, for example, physical limitations imposed by the bar code format. Digital transaction documents include, for example, numeric, alphabetic, or alphanumeric data, an index, or other data values. Digital transaction documents represent, for example, boarding pass information, e-ticket information, ticket information, credit card information, debit card information, automated teller machine card information, identification information, account information, electronic payment information, wire transfer information, purchase information, security information, affinity information, shopping lists, coupons, gift cards, customer loyalty and incentive program information, and contest information.

A “personal digital device” (“PDD”) is a digital device that can be personalized for the user. In one aspect, PDD's may be easily carried on the person, and include such devices as mobile phones, personal digital assistants (“PDA”), mobile gaming devices, mobile audio and video players, fobs, USB Flash drives, and advanced remote control units. In another aspect, PDD's may be intended for use at a fixed location in a home, office or vehicle, and include such devices as external hard drives, on-demand cable boxes, desktop personal computers, smart appliances, and so forth. Personal digital devices are suitable for many uses, including communications, entertainment, security, commerce, guidance, data storage and transfer, and so forth, and may be dedicated to a particular use or may be suitable for a combination of uses. Personal digital devices may have various capabilities that may be used to present digital transaction documents and secured DTD's to transaction facilities, including speakers, screens, printers, wired personal area networks such as USB and FireWire, wireless personal area networks such as IrDA, Bluetooth, UWB, Z-Wave and ZigBee, wireless local area networks such as WiFi, SMS text messaging, SS7 signaling protocols, and the MoBeam technology. Personal digital devices may use many of these same capabilities request digital transaction documents, although they may or may not have an independent capability of accessing a network. The techniques described herein enable the large and growing population of personal digital devices to securely acquire digital transaction documents from a distributor for use with a transaction facility.

A “trusted personal digital device” is a personal digital device that is provided with a security feature, a security capability, or both. An example of a security feature is a unique device identifier. Examples of security capabilities include the capability of decrypting encrypted digital transaction documents, and of verifying digital signatures.

A “transaction facility” is something that is designed or created to enable a transaction, including digital electronic aspects thereof. Examples of transaction facilities include Internet commerce web pages, airport security checkpoints, airport gate check-in counters, building and vehicle secure entry points, event, stadium, arena and destination entry stations, banks and brokerages, and brick-and-mortar points-of-sale such as retail stores and warehouses. The transaction facility includes suitable ways to receive digital information from the user, including wired ports such as USB and memory card readers, wireless ports such as optical, Bluetooth and others, hybrid networks such as intranets, local area networks, and the internet, and barcode readers and scanners.

A “distributor” is a facility such as a server for issuing or distributing digital transaction documents. Distributors are present in a variety of different transaction types, including, for example, security, financial, and commercial. In commercial matters, for example, the distributor may be or may represent any type of business selling or licensing products, such as retail promotions, deals, schemes, tickets, products, loyalty cards or similar schemes to its customers. Distributors include manufacturers, retailers and stores such as Wal-Mart, Costco and Target, promotional document consolidators, and so forth. Distributors may have physical presence, virtual presence on the internet and/or other networks, mobile portals via a distribution server, and so forth. Distributors may be part of a transaction facility, or may be independent of transaction facilities. Customers may have direct or indirect access to the distributors for requesting promotional documents.

A “secured DTD server” is a facility such as a server that generates secured digital transaction documents and securely delivers the secured digital transaction documents to any trusted personal digital device. The secured DTD server may also provide verification and reporting services as desired. In the redemption of promotional documents at a point-of-sale, for example, the secured DTD server may receive the promotion number, transaction data, and the unique personal digital device identifier from the point-of-sale terminal for each transaction, and may maintain an audit trail. Optionally, if the point-of-sale terminal has internet access, the secured DTD server may interact with the point-of-sale to handle problems, such as detecting expired promotional documents, limiting the number of redemptions, and detecting personal digital devices reported lost or stolen.

The delivery mechanisms within the system are independent of the servers and devices and includes all of the following variables: transport (Internet, web, mobile SMS, MMS, WAP, SS7, and other such channels), type of digital terminals, and type of transaction (security, credit, debit, gift-cards, promotions, and other transaction types). At the points-of sale, any standard way and evolving ways for delivering digital transaction documents may be used, including short codes, bar codes (including 1-D and 2-D bar codes), paper codes, Near Field Communications (“NFC”) technology, digital data streams, packets, and so forth. The delivery technique is set by the transaction facility (e.g. a store or the retailer to redeem the promotion under use).

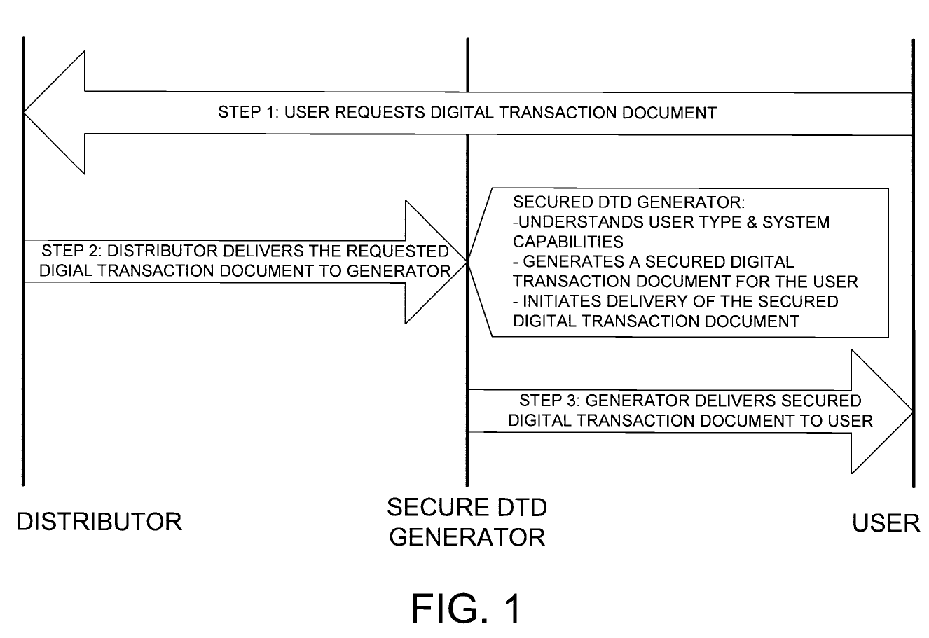

FIG. 1 shows basic functional aspects of an illustrative system for securely generating and delivering digital transaction documents using a trusted personal digital device. A user (for example, a customer in a commercial transaction) requests one or more digital transaction documents (for example, a promotions document such as a coupon) from a distributor using her trusted personal digital device. The distributor sends digital information representing the requested transaction document electronically to a secured DTD generator. The distributor and secured DTD generator are logically distinct. Having acquired the unique identifier of the trusted personal digital device either directly from the trusted personal digital device or indirectly through the distributor, the secured DTD generator constructs a secured DTD, and delivers the secured DTD electronically to the user's trusted personal digital device. Delivery preferably is from the secured DTD generator directly to the user, but may be through the distributor since encryption and data-signing prevents any tampering even by a distributor.

Although not shown in FIG. 1, the secured DTD generator may perform other functions as well. In the case of digital coupon redemption, for example, a customer may submit the digital coupon in either encrypted or decrypted form, depending on the wishes of the distributor and capabilities of the point-of-sale. When presented in encrypted form, the encrypted digital coupon may be sent electronically to the secured DTD generator, which may decrypt and process the encrypted information. Whether presented in encrypted or decrypted form, the coupon may be checked by the secured DTD generator to ensure that it is legitimate and has not expired. Moreover, the secured DTD generator may aggregate redemption information for each distributor, and use the aggregated information in such ways as to limit the number of redemptions, and to prepare a comprehensive report for each distributor. The secured DTD generator may also prepare a digital audit trail for fraud detection and mitigation.

The advantages of this illustrative system for commercial businesses, for example, include the following. First, there is no needed for any paper documents (although the DTC or secured DTD may be printed out for presentation at the transaction facility, if desired) so that depending on the business arrangements and economies of scale, document distribution is very inexpensive and document handling costs are substantially eliminated. Second, the system provides an industry standard and graded solution for promotions redemptions. Third, the system provides a clean separation of business verticals and the promotions industry. Fourth, the system provides robust security, fraud detection, and fraud prevention. Fifth, the system provides for comprehensive and flexible reporting. Sixth, the system provides more control to the distributor as well as enhanced security.

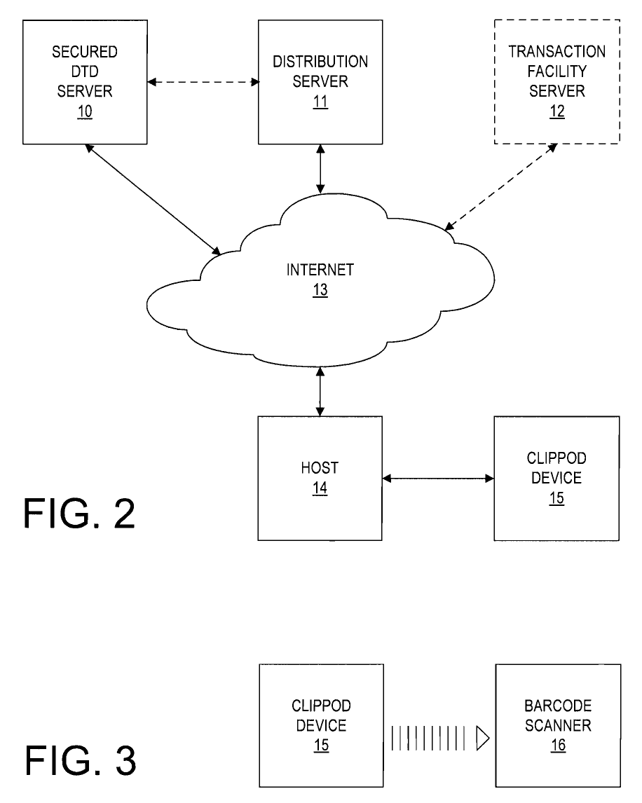

FIG. 2 shows an illustrative system for the secure handling of digital transaction documents, that is particularly suitable for the redemption of digital coupons and other digital promotional documents within the current commercial infrastructure. The system of FIG. 2 involves personal digital devices, and in particular for the commercial environment, mobile personal digital devices such as those that incorporate the MoBeam® technology available from Ecrio Inc. of Cupertino, Calif., USA, for transmitting information to standard point-of-sale (“POS”) barcode scanners. In particular, the ClipPod™ device available from Ecrio Inc. of Cupertino, Calif., USA, is a small, lightweight, simple and inexpensive electronic device that is particularly useful for this purpose. The ClipPod device and similar devices offer an extremely satisfying user experience at the point-of-sale because of their simplicity and convenient shape, size and weight, and the speed, reliability, and ease-of-use of the MoBeam technology for presenting barcodes and other types of digital transaction documents to standard POS barcode scanners. While some of the description herein regarding secured digital transaction documents focuses on the ClipPod device, it is applicable to personal digital devices generally.

As shown in FIG. 2, a ClipPod device 15 is connected to a local host 14 in any suitable manner. Both wired connections such as USB and so forth, and wireless connections such as Bluetooth, infrared, and so forth are suitable. The host 14 illustratively is a personal computer running a suitable web browser, such as the Windows® Internet Explorer® web browser available from Microsoft Corporation of Redmond, Wash., USA, the Firefox® web browser available from the Mozilla Foundation of Mountain View, Calif., USA, or the Safari™ web browser available from Apple Inc. of Cupertino, Calif., USA. Alternatively, the host 14 may run a front-end program or user interface driven program to handle communications. Alternatively, any device having access to the internet may be used, including, for example, mobile personal digital devices such as personal digital assistants, smart devices, and the iPhone™ mobile digital device, and various mobile personal digital devices running operating systems such as Windows Mobile®, Java™ and Linux; as well as devices such as cable boxes, internet appliances, and smart home/business appliances with internet access.

The host 14, a secured DTD server 10, a distribution server 11, and optionally a transaction facility server 12 are connected to the internet in any suitable manner, illustratively in accordance with the HTTP protocol. The secured DTD server 10 and the distribution server 11, which are logically distinct, may also communicate to one another using methods other than the internet 13. The user simply plugs the ClipPod device 15 into the host 14 to initiate the process of loading secured digital transaction documents onto the ClipPod device 15, which is a type of trusted personal digital device. The loader program may be any suitable program, including a program that resides on the host and pulls digital transaction documents from the secured DTD server 10, or a browser-based plug-in object or webdriver which operates independently within the web browser to load to the ClipPod device 15 digital transaction documents pushed by the secured DTD server 10. The loader program may have additional functionality if desired, such as the capability to manage content on the ClipPod device 15, or such functionality may be provided in other ways such as through a website or on the ClipPod device itself. A suitable loader program is described in U.S. Provisional Patent Application Ser. No. 61/201,448 filed Dec. 10, 2008 (Naming applicants Srinivasa Upadhya and Mayank Bhatnagar, and entitled “Apparatus, method and system for loading digital transaction documents to a personal digital device, Attorney Docket No. 1810-031-PRV), which hereby is incorporated herein in its entirety by reference thereto.

While only a single distribution server 11 is shown in FIG. 2, the server 11 represents either a single server model or a many server model. A single server model is appropriate for a large organization such as a retailer with house branding or a governmental entity, while a many server model is appropriate for a retail model that handles a variety of different brands of products.

FIG. 3 shows the ClipPod device 15 in use at a transaction facility equipped with a bar code scanner 16, such as, for example, at a point-of-sale (“POS”) for digital coupon redemption at retail. In the POS example, the shopper disconnects the ClipPod device 15 from the host 14, carries the ClipPod device 15 to the POS, and at checkout redeems promotional documents by transmitting a pulsed beam of light from the ClipPod device 15 to the barcode scanner 16, using information stored in the memory of the ClipPod device 15. The pulsed beam of light simulates the long-and-short sequencing of preferably a standard barcode representative of the applicable coupons.

The techniques may be used to access many other goods and services in addition to conventional commercial services. For coupon applications, for example, the customer may “beam” a barcode representing a manufacturer's or retailer's offer to a laser scanner at the point of sale, to apply the discount at checkout. For purchasing applications, for example, the customer may “beam” a barcode representing a credit card or debit card number to a laser scanner at the point of sale, to complete a purchase. For ticketing applications, for example, the attendee may “beam” a barcode representing a ticket for an event such as a movie or sports event on demand to a laser scanner at the event site entrance. For customer loyalty and incentive programs, for example, rather than carrying a stack of bulky plastic cards, the customer may “beam” barcodes representing her account information to laser scanners at the checkstand. For contests and drawings, for example, retailers looking to increase traffic in their locations can distribute to shoppers barcodes representing promotional documents and entries in contests. The shoppers can then “beam” the barcodes to laser scanners when visit the retailers' stores to enter the contests and drawings for special prizes.

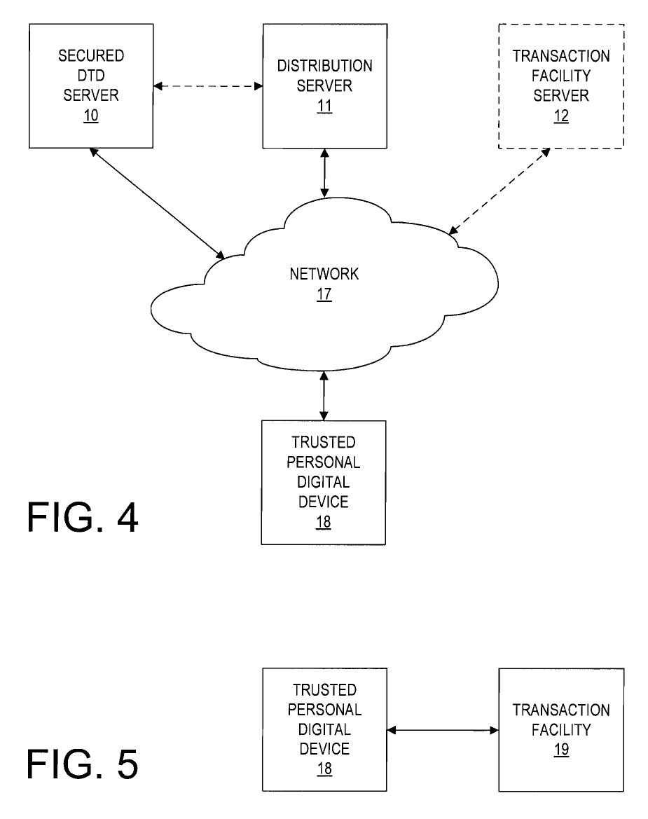

FIG. 4 shows an illustrative system for the secure handling of digital transaction documents, which is similar in some respects to the system of FIG. 2 but is a generalized version thereof. A trusted personal digital device 18 is connected to a network 17 in any suitable manner, either through a host (not shown) or through its own capability to connect to the network 17. If connected through a host, the trusted personal digital device 18 may communicate with the host 14 in any suitable manner, such as through wired technologies, wireless technologies, cellular technology, phone line, dedicated service line (“DSL”), cable connection, or other known remote access technology. A secured DTD server 10, a distribution server 11, and optionally a transaction facility server 12 are connected to the network 17 in any suitable manner. The secured DTD server 10 and the distribution server 11, which are logically distinct, may also communicate to one another using methods other than the network 17. The network 17 may be any type of network, including the internet, a local area network (“LAN”), a wide area network (“WAN”), an intranet, an extranet, a cellular network, a cable network, other types of wired or wireless network, or any combinations of the foregoing. The secured DTD server 10, the distribution server 11, the transaction facility server 12, and the trusted personal digital device 18 may all be considered to be “networked” together because they are capable of communicating with one another over the network 17, regardless of whether the communication is direct or indirect as through an intervening host, server, gateway, proxy server, or the like.

FIG. 5 shows the trusted personal digital device 18 in communication with a transaction facility 19, which may be physical or virtual. Any suitable communications may be used. Where the trusted personal digital device 18 is mobile, for example, the user may carry the trusted personal digital device 18 to a physical transaction facility 19, and the trusted personal digital device 18 may communicate a digital transaction document or a secured DTD to the transaction facility 19 in any desired manner, such as electrically by wired or wireless communication, optically by use of the MoBeam technology, audibly by a special tone or sounds embedded in a melody or a tone, or even physically by printing out a paper bar code at the transaction facility and presenting that printed bar code to a bar code reader at the transaction facility. Where the trusted personal digital device is not mobile, the user may print out a paper bar code which may be carried to the physical transaction facility 19 and presented to a bar code reader. Where the transaction facility 19 has a virtual presence such as through a transaction facility server 12 (FIG. 4), the trusted personal digital device 18 (mobile or not) may communicate a digital transaction document or a secured DTD to the transaction facility 19 over the network 17, either remotely or on-site.

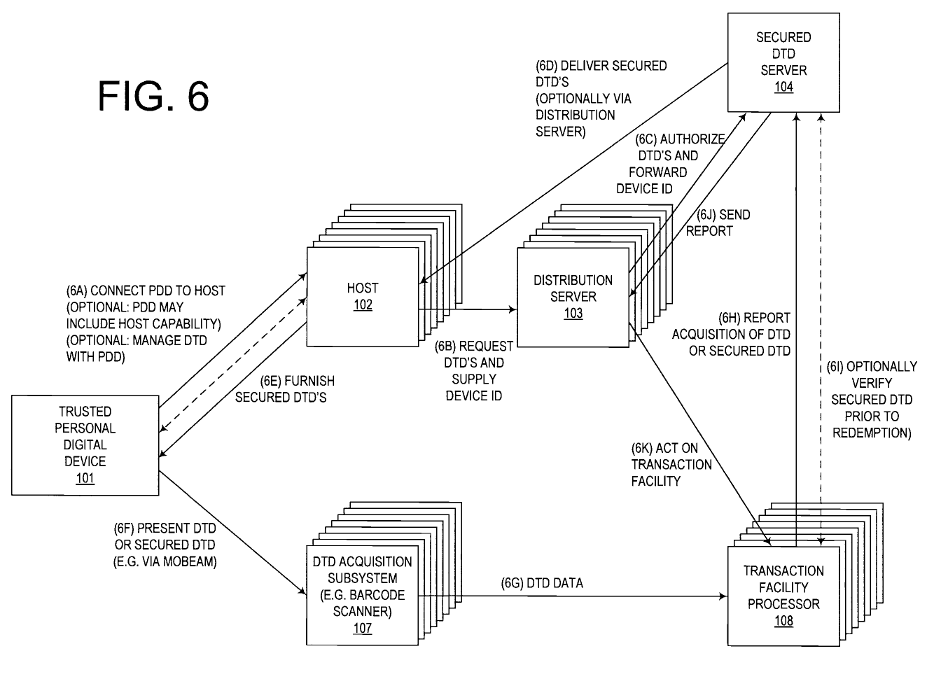

FIG. 6 shows in detail a suitable sequence of operations for one illustrative implementation of a system for handling secured digital transaction documents (“sDTD”), which uses a secured digital transaction document server (“DTD server”) and a trusted personal digital device (“PDD”). The sequence of operations shown in FIG. 6 is as follows.

Operation 6A. The trusted PDD 101, illustratively a mobile PDD such as a ClipPod device that accesses the Internet through a host, is connected to a host 102 (illustratively by plugging into a USB connector of a personal computer, a kiosk computer, or a computer at a point-of-sale, or by using Bluetooth or other wireless communication) running a secured DTD client or a suitable web browser plug-in. If desired, various content management functions may be performed by the host 102 on the PDD. The trusted PDD 101 may be used with any number of different hosts at different times. It will be appreciated that where the trusted PDD is able to access the Internet directly, a host is not required.

Operation 6B. The host 102 to which the trusted PDD 101 is connected requests one or more digital transaction documents (“DTD's”) from one or more distribution servers 103. In the case of retail, for example, the DTD's may be digital promotional documents such as coupons from the web site of a manufacturer or retailer. The request includes the unique identifier of the trusted PDD 101.

Operation 6C. The distribution server 103 sends the requested DTD and the unique PDD identifier to a secured DTD server 104, which creates a secured DTD (“sDTD”). The sDTD is protected by encryption. Where the transaction facility is equipped to process sDTD's, the encryption may be end-to-end encryption (“E2EE”) which can be decrypted only by the sDTD server 104 to maintain security throughout the process. Where the transaction facility is not equipped to process sDTD's, the encryption may be public/private key encryption wherein the trusted mPDD provides a public key to the sDTD server 104 for the encryption, and then uses its private key to decrypt the sDTD for presentation at the transaction facility. The sDTD server may digitally sign the sDTD for additional security.

Operation 6D. The secured DTD server 104 delivers the sDTD's to the host 102. The methodology involving the host, the distribution server, and the sDTD server may be varied. One variation of the methodology is for the secured DTD server 104 to provide the sDTD's to the distribution server 103, which then forwards the sDTD's to the host.

Operation 6E. In turn, the host 102 furnishes the sDTD's to the trusted PDD 101.

Operation 6F. The PDD 101 is removed from the host 102 and taken to a transaction facility, where either the decrypted sDTD or the sDTD itself is beamed using the MoBeam technology or otherwise presented to a DTD acquisition subsystem 107 such as a bar code laser scanner. In retail transactions, for example, the transaction facility may be a point-of-sale. Although beaming the decrypted sDTD or the sDTD itself to a bar code laser scanner using the MoBeam technology is a particularly convenient solution, other wired and wireless techniques may be used to present the DTD to the DTD acquisition subsystem 107.

Operation 6G. The output of the DTD acquisition subsystem 107 is digital data representing either sDTD's or DTD's without encryption.

Operation 6H. Where the transaction facility has bar code laser scanners but does not have real-time internet access, the trusted PDD 101 preferably decrypts the sDTD and beams the DTD to the bar code laser scanner using the MoBeam technology. The DTD's are accepted and processed over a period of time by a transaction facility processor 108, and then batched and reported to the secured DTD server 104 for further processing. If the transaction facility is a point-of-sale (“POS”) and the DTD is a coupon, for example, the POS may apply the discount or take other appropriate action with or without verification.

Operation 6I. Where the transaction facility has real-time access to the secured DTD server 104 and suitable programming or client software, the transaction facility processor 108 may furnish the sDTD's to the secured DTD server 104 for verification, and upon approval by the sDTD server 104, receive DTD information from the secured DTD server 104 for handling. Encryption may be used between the transaction facility processor 108 and the secured DTD server 104 to maintain security. Verification performed by the secured DTD server 104 includes checking both the PDD device identifier and the DTD against issuance records maintained by the secured DTD server 104, to ensure that only original DTD's are being presented at the transaction facility (if disallowance of copies is important to the distributor), and that the presentation is being done by the person (specifically, the PDD as surrogate) to whom the sDTD's were issued. DTD's may be presented in this manner at any number of transaction facilities having respective scanners and client systems.

Operation 6J. The secured DTD server 104 generates a report on transactions for each of the distributors (distribution servers 103). The report may include data on potential fraudulent activity. These transactions may be done live or collected in a timely fashion to reconcile whenever possible by the distributor.

Operation 6K. The distributors (distribution servers 103) takes appropriate action on the transaction facility. In the case of retail transactions wherein the transaction facility is a point-of-sale, for example, each distribution server 103 may compensate the point-of-sale for coupon redemption based on the report from the secured DTD server 104. Advantageously, manufacturers and retailers need not run any special server software, and the coupon verification and redemption processing is entirely outsourced. Any number of distributors may provide coupons to a particular PDD, and any number of points-of-sale may redeem the coupons from the particular PDD.

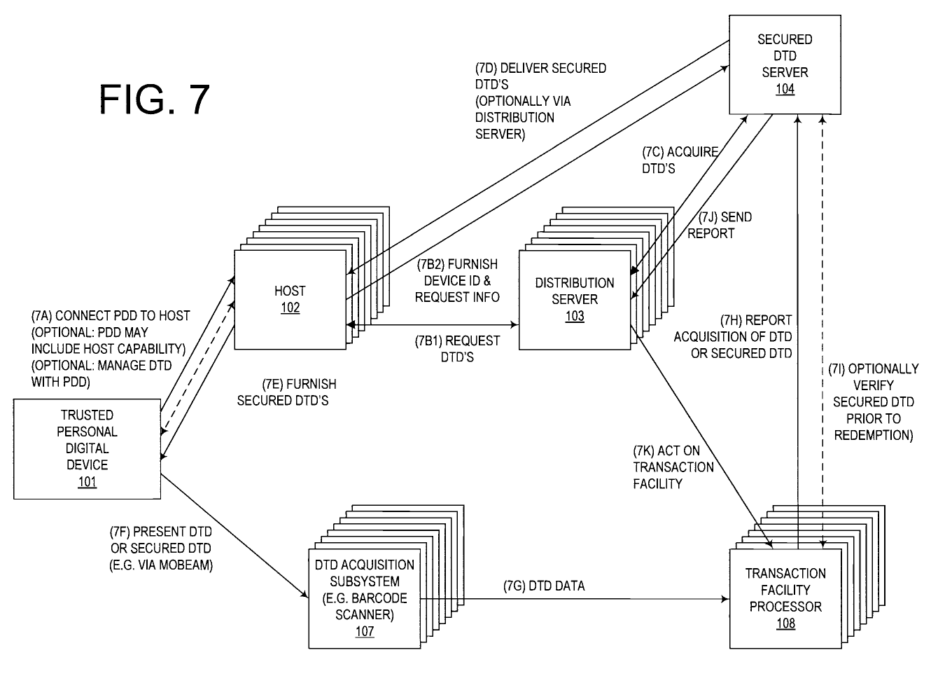

FIG. 7 shows in detail a suitable sequence of operations for an illustrative implementation of a system for handling secured digital transaction documents (“sDTD”). Operations 7A, 7D, 7E, 7F, 7G, 7H, 7I, 7J and 7K correspond to operations 6A, 6D, 6E, 6F, 6G, 6H, 6I, 6J and 6K of FIG. 6. A difference between the sequence of operations of FIG. 6 and the sequence of operations of FIG. 7 is that the unique identifier of the trusted PDD 101 is not provided to the distribution server 103. This difference is found in operations 7B1, 7B2 and 7C, which are as follows.

Operation 7B1. The host 102 to which the trusted PDD 101 is connected requests one or more digital transaction documents (“DTD's”) from one or more distribution servers 103. In the case of retail, for example, the DTD's may be digital promotional documents such as coupons from the web site of a manufacturer or retailer.

Operation 7B2. Concurrent with the request for the DTD's, the host 102 furnishes the unique identifier of the trusted PDD 101 to the secured DTD sever 104.

Operation 7C. The secured DTD server 104 creates secured DTD's using the unique identifier of the trusted PDD 101 received from the host 102 and the requested DTD's from the distribution server 103. The requested DTD's may be acquired in any desired manner. In one technique, a request identification code is supplied by the distribution server 103 to the host 102, which in turn supplies the request identification code and distribution server address to the secured DTD server 104 along with the unique identifier of the trusted PDD 101. The secured DTD server 104 then accesses the appropriate distribution server 104 and supplies the request identification code, in response to which the appropriate distribution server 104 furnishes the requested DTD's. In another technique, the particular distribution server 103 receiving the DTD request acquires the address of the host 102, and supplies the requested DTD's along with the address of the host 102 to the secured DTD server 104. The secured DTD server 104 then contacts the host 102 for the unique identifier of the trusted PDD 101. In another technique, the particular distribution server 103 receiving the DTD request acquires the address of the host 102, and the secured DTD server 104 acquires the address of the host 102 when the unique identifier of the trusted PDD 101 is furnished. The secured DTD server 104 then polls various distribution servers using the address of the host 102 until the particular distribution server 103 which received the DTD request detects a match of the host addresses, and in response supplies the requested DTD's to the secured DTD server 104.

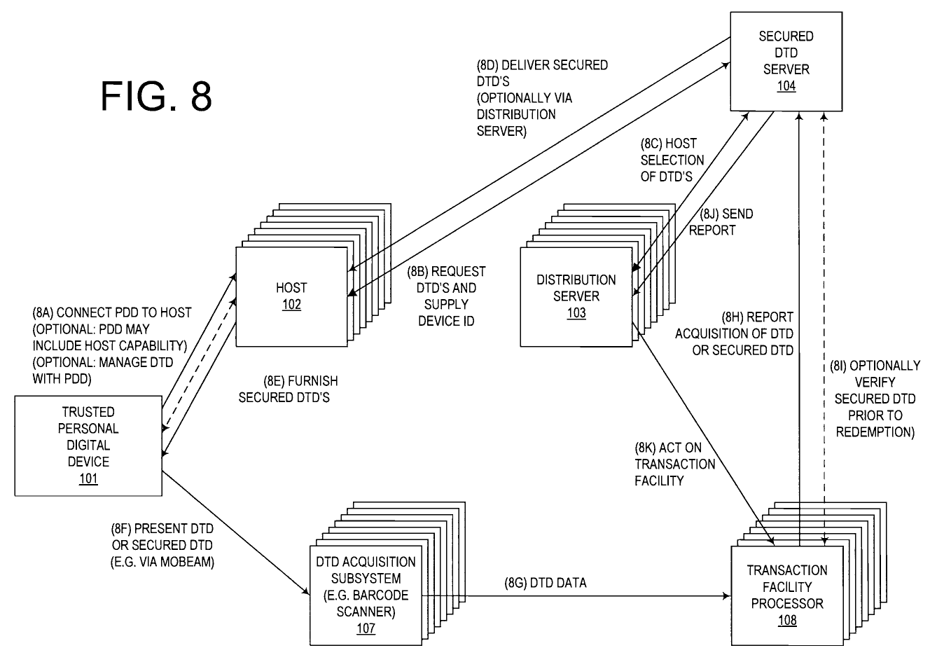

FIG. 8 shows in detail a suitable sequence of operations for an illustrative implementation of a system for handling secured digital transaction documents (“sDTD”). Operations 8A, 8D, 8E, 8F, 8G, 8H, 8I, 8J and 8K correspond to operations 6A, 6D, 6E, 6F, 6G, 6H, 6I, 6J and 6K of FIG. 6. A difference between the sequence of operations of FIG. 6 and the sequence of operations of FIG. 8 is that the host 102 browses the various distribution servers 103 through the secured DTD server 104, which if desired, may manage DTD requests and thereby relieve the distribution servers 103 of this task. If desired, the secured DTD server 104 may provide a common interface to the various distribution servers 103, to enhance the user's experience. The unique identifier of the trusted PDD 101 is not provided to the distribution server 103. This difference is found in operations 8B and 8C, which are as follows.

Operation 8B. The host 102 to which the trusted PDD 101 is connected accesses the secured DTD server 104 in order to browse the distribution servers 103 for desired DTD's. A DTD request may be handled either by the secured DTD server 104 or by the particular distribution server 103 which is responsible for the desired DTD. In either case, the host 102 furnishes the unique identifier of the trusted PDD 101 to the secured DTD sever 104 concurrently with the request for the DTD's.

Operation 8C. The secured DTD server 104 creates secured DT D's using the unique identifier of the trusted PDD 101 received from the host 102 and the requested DTD's from the distribution server 103. Where the distribution servers 103 process DTD requests from the user, the requested DTD's are sent to the secured DTD server 104. Where the secured DTD server 104 processes DTD requests from the user, the requested DTD's are requested by the secured DTD server from the distribution servers 103, thereby relieving the distribution servers 103 of the task of managing DTD requests from numerous users. User information may be provided to the distributors (distribution servers 103) as part of the reporting operation 8J.

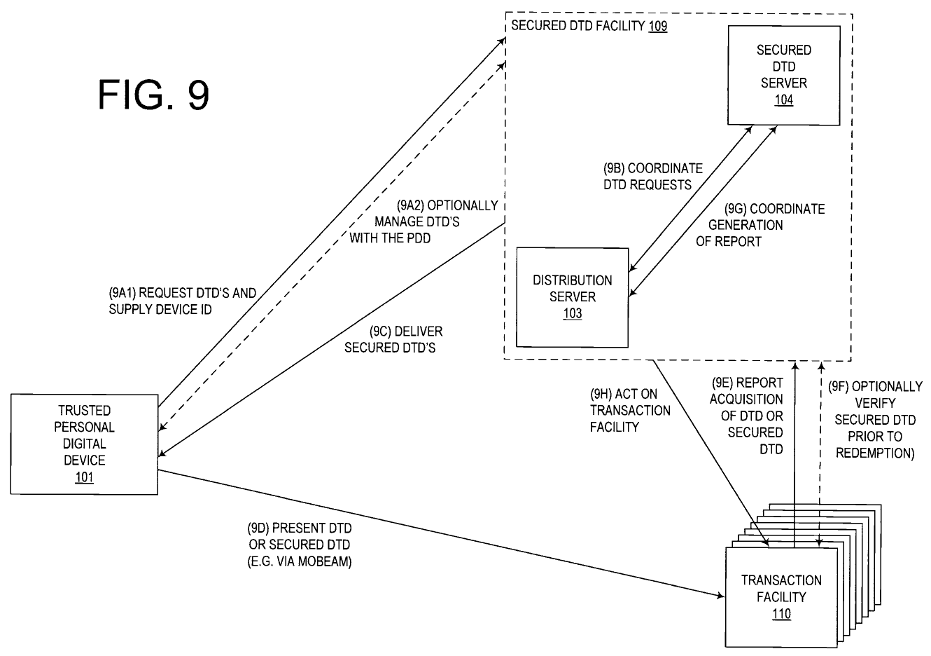

FIG. 9 shows in detail a suitable sequence of operations for one illustrative implementation of a system for handling secured digital transaction documents (“sDTD”), in which one or more distribution servers 103 and the secured D-rD server 104 are under common control or are contractually organized so as to form a secured DTD facility 109. As used herein, the term “server” refers to a computer program that provides services to other computer programs and their users in the same or other computers, and may also refer to the computer on which the program runs and the memory in which the program is stored. The distribution server 103, for example, is logically distinct from the secured DTD server 104, regardless of whether the respective programs run on the same computer or on respective computers. The logical distinctiveness of these servers enables appropriate security levels to be used and enforced; for example, distribution of the DTD's from the distribution server 103 is a low security activity, while access to the secured DTD server is strictly restricted so that strong security may be maintained. Communication between servers is handled in any way that is suitable for the physical implementation, including, for example, network calls, local calls, and interprocess communication (“IPC”). The sequence of operations shown in FIG. 9 is as follows.

Operation 9A1. The trusted PDD 101, which illustratively is shown here without the host 102 (i.e. the trusted PDD 101 includes independent network access capabilities), requests one or more digital transaction documents (“DTD's”) from the secured DTD facility 109. The user may browse various DTD's using just one user interface. The request includes the unique identifier of the trusted PDD 101. A hosted PDD may be used if desired.

Operation 9A2. If desired, various content management functions may be performed on the trusted PDD 101, in cooperation with the secured DTD facility 109.

Operation 9B. DTD requests and the generation of sDTD's are handled in a coordinated manner by the distribution servers 103 and the secured DTD server 104.

Operation 9C. The secured DTD facility 109 delivers the sDTD's to the trusted PDD 101.

Operation 9D. The PDD 101 is used to present either decrypted sDTD or the sDTD itself to a transaction facility 110. The transaction facility 110 may be physical or virtual, the trusted PDD 101 may or may not be mobile, and the presentation may be done on-site or remotely.

Operation 9E. Where the transaction facility 110 does not have real-time internet access, the trusted PDD 101 preferably decrypts the sDTD before presentation. The DTD's are accepted and processed over a period of time by the transaction facility 110, and then batched and reported to the secured DTD facility 109 for further processing. If the transaction facility 110 is a point-of-sale (“POS”) and the DTD is a coupon, for example, the POS may apply the discount or take other appropriate action with or without verification.

Operation 9F. Where the transaction facility 110 has real-time access to the secured DTD facility 109 and has suitable programming or client software, the trusted PDD 101 may present the sDTD and the transaction facility 110 may furnish the sDTD's to the secured DTD facility 109 for verification, and upon approval by the secured DTD facility 109, receive DTD information from the secured DTD facility 109 for handling. Encryption may be used between the transaction facility 110 and the secured DTD facility 109 to maintain security.

Operation 9G. The secured DTD facility 109 generates a report on transactions for each of the distributors (distribution servers 103). The report may include data on potential fraudulent activity. These transactions may be done live or collected in a timely fashion to reconcile whenever possible by the distributor. Report generation may be coordinated between the distribution servers 103 and the secured DTD server 104.

Operation 9H. The secured DTD facility 109 takes appropriate action on the transaction facility. In the case of retail transactions wherein the transaction facility is a point-of-sale, for example, the secured DTD facility 109 may compensate each of the points-of-sale for respective coupon redemptions based on the report. Advantageously, retailers need not run any special server software or need run only very simple software, and the coupon verification and redemption processing is entirely outsourced.

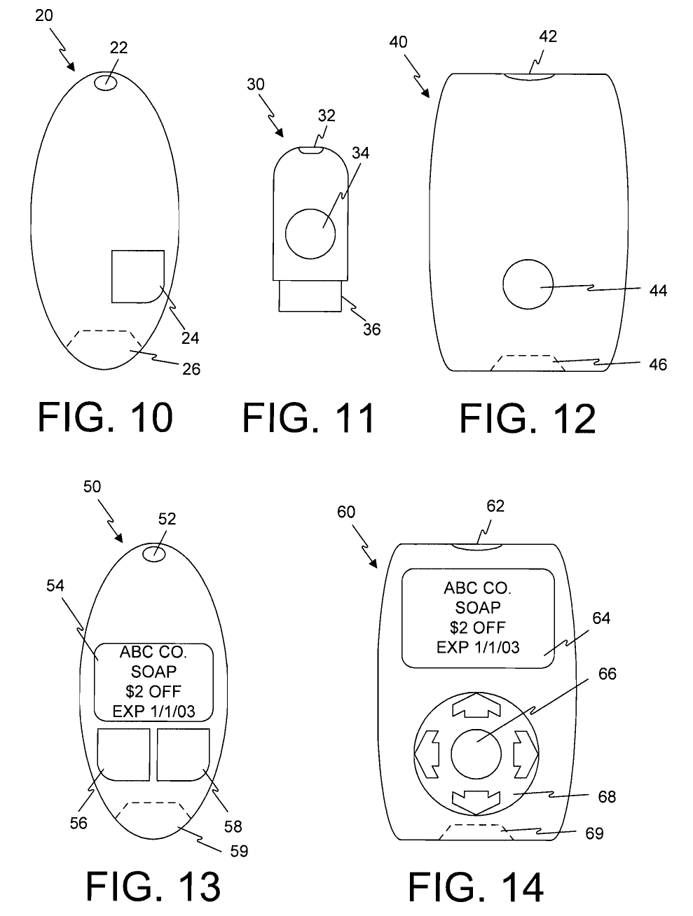

FIG. 10 through FIG. 14 show various examples of ClipPod-type devices. FIG. 10 shows a very simple device 20 of a oval configuration that has a light source 22, an activation button 24, and a USB connector 26. FIG. 11 shows a very simple device 30 of a USB stick configuration that has a light source 32, an activation button 34, and a built-in USB plug 36. FIG. 12 shows a very simple device 40 of a rectangular configuration that has a light source 42, an activation button 44, and a USB connector 46. FIG. 13 shows a device 50 of a oval configuration that has a light source 52, a display screen 54, navigation and select buttons 56 and 58, and a USB connector 59. FIG. 14 shows a device 60 of a rectangular configuration that has a light source 62, a display screen 64, a select button 66, a navigation disk 68, and a USB connector 69.

Devices such as 50 and 60 which include display screens (54 and 64 respectively) and navigation controls (56/58 and 68 respectively) provide users of the devices, illustratively shoppers, with the ability to scroll through individual data codes to find the particular transaction document that the shopper wishes to transmit to a particular barcode scanner. Thus, such devices may store multiple different pieces of information, such as coupons, admission tickets, credit card information, and so forth, which may be selected and transmitted to one or more barcode scanners at different times, as desired by the shopper. The display screens also may be used to display product views or other representative images, and even static visual images of barcodes to enable reading by scanners such as charge coupled device (CCD) scanners.

While the various examples of ClipPod-type devices shown in FIG. 10 through FIG. 14 are particularly suitable for digital redemption for retail, other devices may also be used.

The digital transaction documents may be stored on the personal digital device in any suitable type of memory. The personal digital device may include, for example, static or dynamic RAM (“SRAM” or “DRAM,” respectively) memory, FLASH memory, or any other type of memory.

Personal digital devices may be used to communicate information to a barcode scanner by light. These devices have light sources such as the device screen and LED's that may be driven by a simulated signal so that light from the light source simulates a reflection of a scanning beam being moved across a static visual image of the barcode. Suitable light transmission techniques and various suitable types of personal digital devices are further described in U.S. Pat. No. 6,685,093 issued Feb. 3, 2004 to Challa et al.; U.S. Pat. No. 6,877,665 issued Apr. 12, 2005 to Challa et al.; U.S. Pat. No. 7,028,906 issued Apr. 18, 2006 to Challa et al.; U.S. Pat. No. 7,395,961 issued Jul. 8, 2008 to Challa et al.; and US Patent Application Publication No. US 2008/0035734, published Feb. 14, 2008 in the name of Challa et al., all of which hereby are incorporated herein in their entirety by reference thereto.

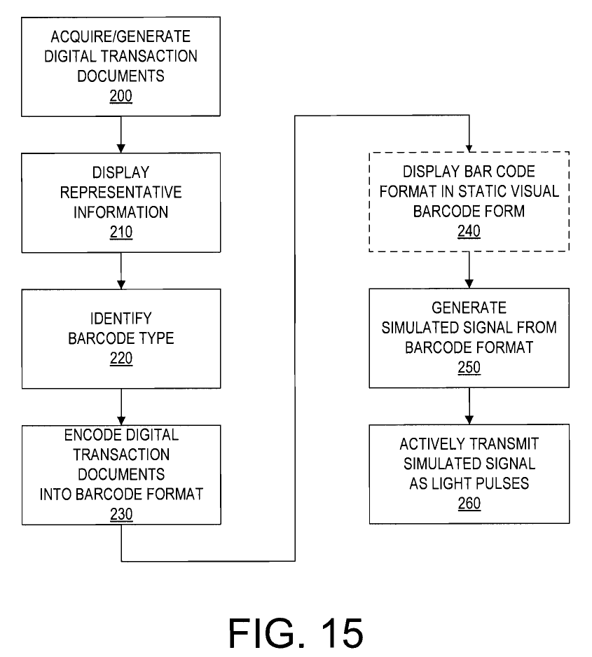

FIG. 15 shows a method of generating a signal for use with a sequential barcode scanner that simulates a barcode with light pulses. The method of FIG. 15 is particularly useful for sequential barcode scanners that use the reflection of a scanning beam being moved over a barcode.

As shown in block 200, digital transaction documents are acquired or generated, and stored in stored locally in memory of the personal digital device.

As shown in block 210, representative information for the digital transaction documents that identifies the digital transaction documents to a shopper of the personal digital device may be presented on an output facility of the device, if so equipped. The output facility may include, for example, a display such as an LCD screen of a PDA or wireless telephone, a speaker, or any other output device for communicating with a shopper. The representative information may include the transaction document itself, or may be other information that the shopper will associate with the transaction document. In order to identify the desired transaction document, the representative information for identifying the transaction document may be rendered, for example, in a textual, numerical, and/or graphical form and displayed on a screen of a suitably equipped personal digital device, or an audio, video or multimedia message that is played by a suitably equipped personal digital device. Promotions may be displayed on a screen of a mobile phone, for example, identifying the item and the terms of the promotional offer. In this manner, the shopper may conveniently identify the transaction document that is to be presented, is being presented, or has been presented to the barcode scanner. If the personal digital device lacks a screen or if the screen is too small, the representative information may be presented in other ways, such as by a spoken message or patterns of tones. Alternatively, the representative information need not be displayed.

As shown In block 220, a desired barcode type is identified. The barcode type may be any type of barcode known in the art, such as, but not limited to, a UPC, EAN, Interleaved 2 of 5, Code 93, Code 128, and Code 39, or specially designed barcode types, including multi-dimensional.

As shown in block 230, the digital transaction documents are encoded into a barcode format for the identified barcode type. The barcode format may be represented, for example, by a binary array. In a typical single-dimensional barcode, for example, the smallest width of a bar or space element of a barcode may be designated as a single element of an array. If the barcode has a width of 256 dots or pixels, and the smallest element of the barcode has a width of 4 dots or pixels, for example, a binary array having sixty four array elements (e.g., a1, a2, . . . , a64) may be used to represent the barcode format. Each array element is assigned a value depending on whether that portion of the barcode is part of a bar or a space. A bar, for example, may be designated as having a value equal to one (e.g., a1=1), and a space maybe designated as having a value equal to zero (e.g., a32=0). The array may also alternatively be a two-dimensional array, such as a bit map, that may be easily displayed on a screen.

As shown in block 240, optionally the transaction documents may be displayed in static visual barcode form. In this manner, a personal digital device can provide a transaction document as a static visual barcode, which may be readable by CCD scanners and some types of sequential barcode scanners. Other visual information may be displayed as well, such as, for example, a visual image of a product corresponding to the transaction document.

As shown in block 250, a signal to simulate the reflection of a scanning beam being moved across a visual image of the barcode format of block 230 is generated from the barcode format. The simulated signal may be generated corresponding to an approximated or measured scanning rate. If the simulated signal is to be generated for a scanner such as a laser scanner that utilizes a scanning rate in the range of about 30 to about 60 scans per second, the simulated signal may be generated using a scan rate within that range of scan rates (e.g., about 45 scans per second). Other types of scanners such as supermarket scanners are much faster, scanning at a rate of about 3000 to about 6000 scans per second. The simulation signal should be generated using a scan rate within that range. Alternatively, the simulated signal may be generated using a variable scan rate that is swept throughout a range of scan rates. Alternatively, as described below with respect to an exemplary infrared transmitter/receiver pair, the scan rate of the scanning beam may be measured where a receiver is available to detect the scanning beam. In this case, once the scanning rate or rates are determined, the signal is generated in block 250 corresponding to this scan rate or rates.

As shown in block 260, the simulated signal is transmitted as light pulses. For purposes of the present description, the term “light” refers to visible light and infrared light spectra. The term “pulse” refers merely to a change in light level; the characteristics of the change, i.e. the specific waveform shape, are not critical. The light pulses may be generated in any visible or infrared wavelength desired by any light source known in the art, such as an LED, a laser, an infrared transmitter, a backlight of an LCD screen, or a light bulb.

Some personal digital devices have light sources that either are not capable of pulsing quickly enough, or the light sources are controlled by application program interfaces (“API”) that for any number of technical or business reasons cannot be modified to pulse the light source as necessary. Some types of personal digital devices may not have any light sources, even though they are capable of receiving or storing information of a type that could usefully be communicated to a barcode scanner. These types of personal digital devices may be enabled for to communicate information to a barcode scanner by light using an accessory as described in US Patent Application US 2008/0128505, published Jun. 5, 2008 in the name of Challa et al., which hereby is incorporated herein in its entirety by reference thereto.

The various embodiments of the invention described herein are illustrative. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention, as set forth in the following claims.

1. A server for securely delivering and managing digital transaction documents, comprising program components in tangible storage medium for:
receiving a digital transaction document (“DTD”) from a logically distinct distribution server;
receiving a unique device identifier that uniquely identifies a trusted personal digital device (“PDD”);
generating a secured DTD in accordance with the DTD and the unique device identifier; and
delivering the secured DTD to the PDD.

2. The server of claim 1 further comprising a program component in tangible storage medium for verifying a secured DTD presented at a transaction facility.

3. The server of claim 1 further comprising program components in tangible storage medium for:
receiving DTD data for a redeemed DTD from a transaction facility;
generating a transaction report from the DTD data; and
delivering the transaction report to the distribution server.

4. A system for securely delivering and managing digital transaction documents, comprising:
a personal digital device (“PDD”) having a memory and a unique device identifier;
a distribution server for distributing a digital transaction document (“DTD”); and
a secured DTD server for generating a secured DTD in accordance with the DTD and the unique device identifier, the secured DTD server being logically distinct from and in communication with the distribution server for receiving the DTD, and being in communication with the PDD for receiving the unique device identifier and for furnishing the secured DTD to the memory of the PDD.

5. The system of claim 4 further comprising a host for generating a request for a secured DTD, wherein:
the PDD is in communication with the host;
the host is networked to the distribution server for requesting the DTD from the distribution server; and
the host is networked to the secured DTD server for furnishing the unique device identifier to the secured DTD server, and for receiving the secured DTD from the secured DTD server.

6. The system of claim 5 wherein the PDD is physically removably connected to the host for communicating therewith.

7. The system of claim 5 wherein the PDD is wirelessly connected to the host for communicating therewith.

8. The system of claim 4 wherein the PDD comprises a component for generating a request for a secured DTD, wherein:
the PDD is networked to the distribution server for requesting the DTD from the distribution server; and
the PDD is networked to the secured DTD server for furnishing the unique device identifier to the secured DTD server, and for receiving the secured DTD from the secured DTD server.

9. The system of claim 4 further comprising:
a transaction facility;
wherein the PDD is adapted for communication with the transaction facility for providing DTD data from the secured DTD to the transaction facility; and
wherein the PDD comprises a component for recovering the DTD from the secured DTD, the DTD data comprising the recovered DTD.

10. The system of claim 4 further comprising:
a transaction facility;
wherein the PDD is adapted for communication with the transaction facility for providing DTD data from the secured DTD to the transaction facility; and
wherein the DTD data comprises the secured DTD.

11. The system of claim 10 wherein the transaction facility comprises a component for verifying the secured DTD.

12. The system of claim 10 wherein the transaction facility is networked to the secure DTD server for verifying the secured DTD.

13. The system of claim 4 further comprising:
a transaction facility;
wherein the PDD is adapted for communication with the transaction facility for providing DTD data from the secured DTD to the transaction facility;
wherein the transaction facility is networked to the secured DTD server for providing the DTD data to the secured DTD server; and
wherein the secured DTD server comprises a component for generating a transaction report from the DTD data.

14. The system of claim 13 wherein the secured DTD server is in communication with the distribution server for providing the transaction report.

15. The system of claim 14 wherein the distribution server is in communication with the transaction facility for compensating the transaction facility in accordance with the transaction report.

16. A method for securely delivering and managing digital transaction documents, comprising:
requesting a digital transaction document (“DTD”) from a distribution server with a personal digital device (“PDD”), the PDD having a memory and a unique device identifier;
providing the DTD requested by the PDD in the requesting step to a secured DTD server from the distribution server, the secured DTD server being logically distinct from the distribution server;
providing the unique device identifier to the secured DTD server from the PDD;
generating in the secured DTD server a secured DTD in accordance with the DTD and the unique device identifier; and
providing the secured DTD to the memory of the PDD from the secured DTD server.

17. The method of claim 16 further comprising providing DTD data from the secured DTD to a transaction facility.

18. The method of claim 17 further comprising:
providing the DTD data from the transaction facility to the secured DTD server;
generating a report in the secured DTD server from the DTD data; and
compensating the transaction facility in accordance with the transaction report.
